(19) United States
(12) Patent Application Publication
(10) Pub. No.: US 2024/0366462 A1
(43) Pub. Date: Nov. 7, 2024

(54) Sleeve-Type Air Pulse Massager

(71) Applicant: Changbao Yin, Changde City (CN)

(72) Inventors: Changbao Yin, Changde City (CN); Quan Zhao, Dongguan City (CN)

(21) Appl. No.: 18/399,172

(22) Filed: Dec. 28, 2023

(30) Foreign Application Priority Data
May 6, 2023 (CN) 202321069785.9

(51) Int. Cl. A61H 9/00

(52) U.S. Cl. CPC A61H 9/0071; A61H 9/0007; A61H 2201/1246; A61H 2201/5025

(57) ABSTRACT

A sleeve-type air pulse massager comprises a front cover, a rear cover, and an upper cover. The front and rear covers interlock to form the massager's outer shell. The outer shell is a cavity structure with an opening at the upper end and hollow inside. The upper cover is placed over the cavity's opening. Inside the cavity, there are a motor mount, a double-headed motor, a PCBA board, a battery, and an air pulse component. The double-headed motor is fixedly mounted on the motor mount. The PCBA board and battery are located on either side of the motor mount, and the PCBA board is electrically connected to both the battery and the double-headed motor. One end of the air pulse component is connected to the output end of the double-headed motor, while the other end is fixed through the upper cover at the opening of the massager's upper end.

### TECHNICAL FIELD

This invention pertains to the field of massager technology, specifically a sleeve-type air pulse massager.

### BACKGROUND TECHNOLOGY

Presently, massagers generally operate through a pounding method, massaging the human body to promote blood circulation and relax muscles. Air pulse wave massagers, a type of massager, generate 50-150 Hz pulsating air waves through mechanical motion. These waves, upon contact with the human body, create resonance for massaging purposes. Existing market air pulse wave massagers have an internal piston structure. The drawbacks of this structure are: 1. The internal piston structure is complex and costly to manufacture; 2. The piston's inner wall and piston in the internal piston type are tightly fitted. This creates significant resistance and heat during operation, potentially causing burns to the human body at high temperatures, preventing continuous operation. Therefore, the applicant has designed a sleeve-type air pulse massager.

### CONTENT OF THE INVENTION

Addressing the deficiencies in existing technology, this invention introduces a sleeve-type air pulse massager. It resolves the issues of the internal piston structure being overly complex and expensive to produce; and the tightly fitted piston inner wall and piston of the internal piston type generating significant resistance and heat during operation. Such heat, when excessive, poses a risk of burning the human body, thereby hindering continuous operation.

To achieve the aforementioned objectives, the invention is realized through technical solutions: A sleeve-type air pulse massager, which includes a front cover, a rear cover, and an upper cover. The front and rear covers interlock to form the massager's outer shell, a cavity structure with an opening at the upper end and hollow inside. The upper cover is placed over the cavity's opening. Within the cavity, there are a motor mount, a double-headed motor, a PCBA board, a battery, and an air pulse component. The double-headed motor is fixedly mounted on the motor mount, with the PCBA board and battery situated on either side of the motor mount. Moreover, the PCBA board is electrically connected to both the battery and the double-headed motor. One end of the air pulse component is connected to the output end of the double-headed motor, while the other end is fixed through the upper cover at the opening of the massager's upper end.

Preferably, the air pulse massager also includes charging pins, of which there are two. These two charging pins are located at the bottom of the massager's outer shell. They penetrate from the outside to the inside of the massager's outer shell and are electrically connected to the PCBA board.

Preferably, the upper cover is designed with air holes, which are in communication with the cavity of the massager's outer shell.

Preferably, the PCBA board is equipped with functional buttons. These functional buttons penetrate the front cover from the inside to the outside and extend to the exterior side of the front cover.

Preferably, the air pulse component includes movable cams, bracket connectors, a movable bracket, an external moving part, an internal guide cup, and connecting seals. There are two movable cams and two bracket connectors. The two movable cams are connected to the output end of the double-headed motor, respectively. The two bracket connectors are installed on the movable cams. Both ends of the movable bracket are fixedly connected to the two bracket connectors. The top of the movable bracket is connected to the external moving part via a pin. The internal guide cup is located inside the external moving part and is fixedly connected at its top end to the opening at the top of the massager's outer shell. The connecting seal is fitted around the outside of the internal guide cup, sealingly connected at one end to the outer wall of the internal guide cup, and at the other end to the outer wall of the external moving part.

Preferably, a gap is formed between the inner wall of the external moving part and the outer wall of the internal guide cup. Additionally, an air chamber is formed between the external moving part and the internal guide cup, which communicates with the air hole.

Preferably, the outer wall of the connecting seal is wave-shaped.

Working Principle: The air pulse massager features a simple overall structure and a sensible design. By incorporating an air pulse component within the massager's shell, which includes movable cams, bracket connectors, a movable bracket, an external moving part, an internal guide cup, and connecting seals, the device operates efficiently. The internal guide cup, situated within the external moving part, leverages a dual-sleeve structure. When the external moving part moves up and down while the internal guide cup remains stationary, air is compressed and expelled from the internal guide cup, creating air pulse waves for massaging purposes. This system, in comparison to traditional piston structures, is simpler and more cost-effective. Furthermore, the connecting seals fitted around the external side of the internal guide cup ensure a waterproof seal. One end of the connecting seal is tightly connected to the outer wall of the internal guide cup, and the other end to the outer wall of the external moving part. This design ensures air expulsion from within the internal guide cup. The gap formed between the inner wall of the external moving part and the outer wall of the internal guide cup eliminates the friction and heat issues prevalent in tightly fitted piston movements, thereby enhancing the product's safety.

This invention provides a sleeve-type air pulse massager, offering the following beneficial effects:
1. The invention, through its simple and rational design, incorporates an air pulse component within the massager's shell. This component includes movable cams, bracket connectors, a movable bracket, an external moving part, an internal guide cup, and connecting seals. With the internal guide cup positioned inside the external moving part and utilizing a dual-sleeve structure, the external moving part's vertical movement, while the internal guide cup remains stationary, creates air compression that is expelled from the internal guide cup. This process forms air pulse waves for massaging purposes. Compared to traditional piston structures, this design is simpler and more cost-effective.
2. The invention, by fitting connecting seals around the outside of the internal guide cup, ensures a sealed connection between one end of the connecting seal and the outer wall of the internal guide cup, and the other end with the outer wall of the external moving part. This configuration not only provides waterproofing but also ensures air is expelled from within the internal guide cup. The gap formed between the inner wall of the external moving part and the outer wall of the internal guide cup eliminates the friction and heating issues common in tightly fitted piston movements, thereby enhancing the product's safety.

### ILLUSTRATION DESCRIPTION

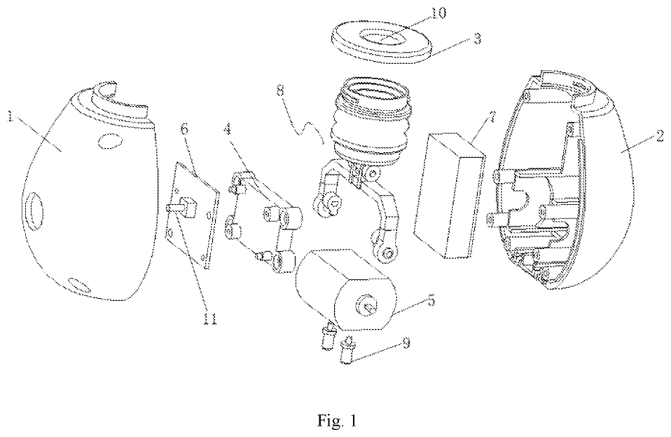

FIG. 1 is an exploded view of the invention.

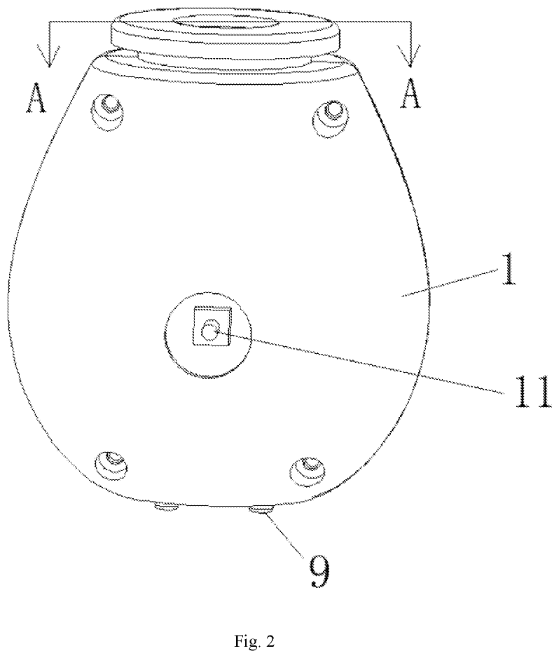

FIG. 2 is a front view of the invention.

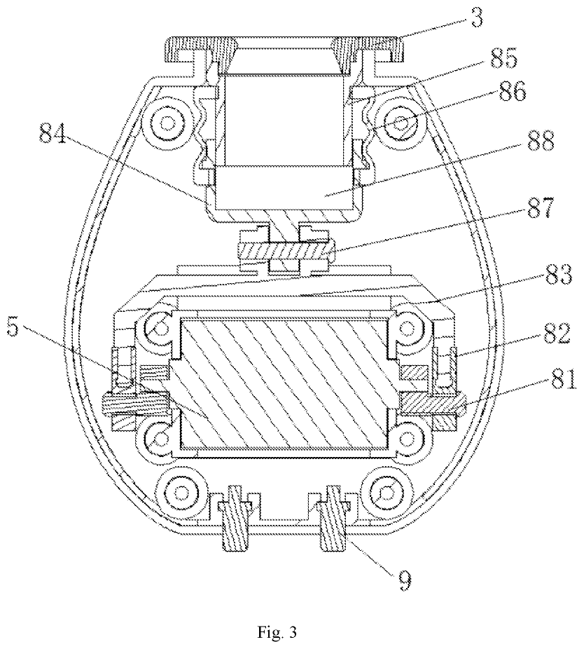

FIG. 3 is a sectional view along line A-A in FIG. 2 of the invention.

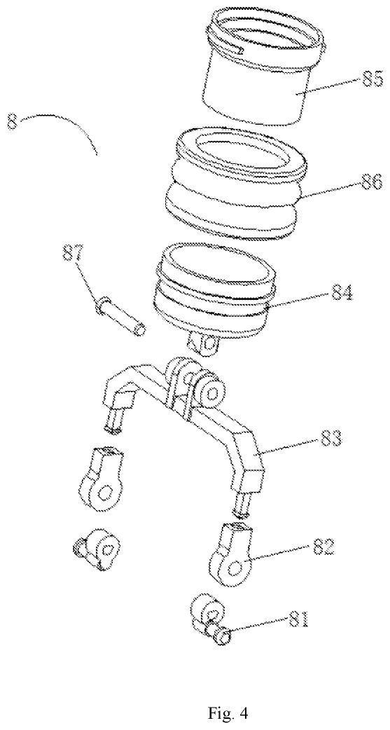

FIG. 4 is an exploded view of the air pulse component of the invention.

Wherein, 1 represents the front cover; 2, the rear cover; 3, the upper cover; 4, the motor mount; 5, the double-headed motor; 6, the PCBA board; 7, the battery; 8, the air pulse component; 81, movable cam; 82, bracket connector; 83, movable bracket; 84, external moving part; 85, internal guide cup; 86, connecting seal; 87, pin; 88, air chamber; 9, charging pin; 10, air hole; 11, functional button.

### EMBODIMENTS

The following describes the technical solutions in the embodiments of this invention, in conjunction with the embodiments of the invention, in a clear and complete manner. Obviously, the described embodiments are just a part of the embodiments of the invention, not all of them. Based on the embodiments in this invention, all other embodiments obtained by those of ordinary skill in the art, without making creative efforts, fall within the scope of protection of this invention.

### Example

Refer to FIGS. 1 to 3. An embodiment of this invention provides a sleeve-type air pulse massager. The air pulse massager comprises a front cover 1, a rear cover 2, and an upper cover 3. The front cover 1 and rear cover 2 interlock to form the outer shell of the massager. This shell is a cavity structure with an opening at the upper end and hollow inside. The upper cover 3 is placed over the opening of the cavity. Inside the cavity, there are a motor mount 4, a double-headed motor 5, a PCBA board 6, a battery 7, and an air pulse component 8. The double-headed motor 5 is fixedly mounted on the motor mount 4, with the PCBA board 6 and battery 7 situated on either side of the motor mount 4. The PCBA board 6 is electrically connected to both the battery 7 and the double-headed motor 5. Functional buttons 11 are located on the PCBA board 6. These functional buttons 11 penetrate the front cover 1 from the inside to the outside and extend to the exterior side of the front cover 1. One end of the air pulse component 8 is connected to the output end of the double-headed motor 5, while the other end is fixed through the upper cover 3 at the opening of the massager's upper end. The air pulse massager also includes charging pins 9, with two such pins. These two charging pins 9 are located at the bottom of the massager's outer shell and penetrate from the outside to the inside of the massager's outer shell, where they are electrically connected to the PCBA board 6.

Specifically, the upper cover 3 is designed with air holes 10, which communicate with the cavity of the massager's outer shell.

Refer to FIGS. 3 and 4. The air pulse component 8 shown in the figures includes movable cams 81, bracket connectors 82, a movable bracket 83, an external moving part 84, an internal guide cup 85, and connecting seals 86. There are two movable cams 81 and two bracket connectors 82. Each of the two movable cams 81 is connected to the output end of the double-headed motor 5, which drives the rotation of the two movable cams 81. The two bracket connectors 82 are each installed on a movable cam 81. Both ends of the movable bracket 83 are fixedly connected to the two bracket connectors 82, and the top of the movable bracket 83 is connected to the external moving part 84 via a pin 87. The internal guide cup 85 is situated within the external moving part 84, and its top end is fixedly connected to the opening at the top of the massager's outer shell. The connecting seals 86 are fitted around the outside of the internal guide cup 85, sealingly connecting one end to the outer wall of the internal guide cup 85 and the other end to the outer wall of the external moving part 84. To facilitate the vertical movement of the external moving part 84, the outer wall of the connecting seals 86 is designed in a wave-shaped form.

Specifically, a gap is formed between the inner wall of the external moving part 84 and the outer wall of the internal guide cup 85. During the vertical movement of the external moving part 84, there is no friction or heat generation. An air chamber 88 is also formed between the external moving part 84 and the internal guide cup 85. This air chamber 88 is in communication with the air holes 10, and the air pulse waves generated by the relative movement of the external moving part 84 and the internal guide cup 85 are expelled through the air holes 10.

Refer again to FIGS. 1 to 4. When using the air pulse massager in this utility model, hold the massager with the air holes 10 aligned with the skin of the human body. Activate the functional buttons 11, and the PCBA board 6 controls the operation of the double-headed motor 5. The rotation of the double-headed motor 5 drives the rotation of the movable cams 81 on the air pulse component 8. This further drives the bracket connectors 82 and the movable bracket 83 connected to the bracket connectors 82 to move up and down. Since the external moving part 84 is fixed to the movable bracket 83 via a pin 87, this creates air pulse waves between the external moving part 84 and the internal guide cup 85. These air pulse waves are expelled through the air holes 10 to achieve the purpose of massaging.

Although embodiments of this invention have been shown and described, it will be understood by those skilled in the art that various changes, modifications, substitutions, and variations can be made to these embodiments without departing from the principles and spirit of the invention. The scope of the invention is defined by the appended claims and their equivalents.

1. An air pulse massager, comprising a front cover (1), a rear cover (2), and an upper cover (3), wherein the front cover (1) and the rear cover (2) interlock to form an outer shell of the air pulse massager, the outer shell is a cavity structure with an opening at an upper end and a hollow inside, the upper cover (3) is placed over the opening, wherein inside the cavity structure, the air pulse massager further comprises a motor mount (4), a double-headed motor (5), a printed circuit board assembly (PCBA) board (6), a battery (7), and an air pulse component (8), wherein the double-headed motor (5) is fixedly mounted on the motor mount (4), the PCBA board (6) and the battery (7) are located on either side of the motor mount (4), the PCBA board (6) is electrically connected to both the battery (7) and the double-headed motor (5), and one end of the air pulse component (8) is connected to an output end of the double-headed motor (5), while another end of the air pulse component (8) is fixed through the upper cover (3) at the opening of the outer shell, and wherein the upper cover (3) is in a ring shape and designed with a single air hole (10), and the air hole (10) communicates with the cavity structure of the outer shell.

2. The air pulse massager according to claim 1, further comprising two charging pins (9) located at a bottom of the outer shell, wherein the two charging pins penetrate the outer shell from outside to inside and electrically connect to the PCBA board (6).

3. (canceled)

4. The air pulse massager according to claim 1, wherein the PCBA board (6) is equipped with functional buttons (11), wherein the functional buttons (11) penetrate the front cover (1) from inside to outside and extend to an exterior side of the front cover (1).

5. The air pulse massager according to claim 1, wherein the air pulse component (8) includes two movable cams (81), two bracket connectors (82), a movable bracket (83), an external moving part (84), an internal guide cup (85), and a connecting seal (86) wherein each of the two movable cams (81) is connected to the output end of the double-headed motor (5), the two bracket connectors (82) are installed on the two movable cams (81) respectively, two ends of the movable bracket (83) are fixedly connected to the two bracket connectors (82) respectively, a top end of the movable bracket (83) is connected to the external moving part (84) via a pin (87), and wherein the internal guide cup (85) is situated within the external moving part (84), a top end of the internal guide cup is fixedly connected to the opening of the outer shell, the connecting seal (86) is fitted around an outside of the internal guide cup (85), one end of the connecting seal sealingly connects to an outer wall of the internal guide cup (85) and another end of the connecting seal sealingly connects to an outer wall of the external moving part (84).

6. The air pulse massager according to claim 5, wherein a gap is formed between an inner wall of the external moving part (84) and the outer wall of the internal guide cup (85), an air chamber (88) is formed between the external moving part (84) and the internal guide cup (85), and the air chamber communicates with the air hole (10).

7. The air pulse massager according to claim 5, wherein an outer wall of the connecting seal (86) is wave-shaped.
